(19) United States
(12) Patent Application Publication
(10) Pub. No.: US 2014/0104138 A1
(43) Pub. Date: Apr. 17, 2014

(54) SYSTEMS AND METHODS FOR AUTOMATIC SWITCHING OF DISPLAY MODES

(71) Applicant: Jeff Brown, Mountain View, CA (US)

(72) Inventor: Jeff Brown, Mountain View, CA (US)

(73) Assignee: Google Inc., Mountain View, CA (US)

(21) Appl. No.: 13/757,558

(22) Filed: Feb. 1, 2013

Related U.S. Application Data
(60) Provisional application No. 61/714,736, filed on Oct. 16, 2012.
(60) Provisional application No. 61/719,802, filed on Oct. 29, 2012.

(51) Int. Cl. G09G 3/00

(52) U.S. Cl. CPC G09G 3/00
USPC 345/1.1

(57) ABSTRACT

Systems and methods for determining when two or more displays should present (mirror) the same content. An example method may include determining whether there is content for display at a first logical display primarily associated with a first display device. And if so, displaying content associated with the first logical display at the first display device; if not, switching to displaying content associated with a different second logical display at the first display device. In one implementation, the second logical display can be a default logical display for switching to. The method can also include informing applications of available logical displays for associating content, and activating/deactivating “mirroring” based on indications from applications. In one implementation, a single application can provide content for the first and second logical display. In another implementation, a first application and different second application can provide content for the first and second logical display, respectively.

### CROSS-REFERENCE TO RELATED APPLICATIONS

This application claims priority and the benefit under 35 U.S.C. §119(e) of U.S. Provisional Patent Application No. 61/714,736, filed 16 Oct. 2012, and of U.S. Provisional Patent Application No. 61/719,802, filed 29 Oct. 2012, all of which the entire contents and substance are hereby incorporated by reference as if fully set forth below.

### BACKGROUND

Many modern computing devices can support more than one display that may be used independently or in tandem to display content associated with various services or applications. Multiple-display technologies are also becoming common on mobile devices (e.g., smartphones and tablets). For example, some mobile devices feature two or more displays integrated into the same device. Also, some mobile devices can display content on one or more external display devices through a direct link such as HDMI, MHL, USB, etc., or wirelessly using a protocol like Miracast or Wifi Display.

Systems with multiple displays can provide different display-mode configurations for determining which display(s) an application's content will be presented on. Conventional multiple-display systems typically utilize a static configuration, requiring user prompt to alter or switch the configuration and, thus, the particular displays an application's content will be presented on. For example, one conventional approach requires a user to effect a mode switch, often with a key press, to toggle between minoring and non-mirroring display modes.

### SUMMARY

Some or all of the above needs may be addressed by certain implementations of the disclosed technology. Certain implementations may include systems and methods for automatically determining when two or more displays should present the same or unique content. According to an example implementation, a method is provided. The method may include associating a first display device with a first logical display and associating a second display device with a second logical display. In one implementation, the first logical display can be a default logical display. The method may further include displaying at the first and second display devices, a first content for viewing associated with the first logical display. The method may determine that there is a second content available for viewing associated with the second logical display and stop, based on the determining, display of the first content for display at the second display device. The method may further include displaying the second content at the second display device.

Other implementations, features, and aspects of the disclosed technology are described in detail herein and are considered a part of the claimed disclosed technology. Other implementations, features, and aspects may be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 depicts an illustration of a computing device, according to an example implementation.

FIG. 2 depicts an illustration of a block diagram of the system with multiple displays presenting mirrored content, according to an example implementation.

FIG. 3 depicts an illustration of a block diagram of the system with multiple displays presenting unique content from two different applications, according to an example implementation.

FIG. 4 depicts an illustration of a block diagram of the system with multiple displays presenting unique content from a same application, according to an example implementation.

FIG. 5 depicts an illustration of a flow diagram of the method, according to an example implementation.

FIG. 6 depicts an illustrative block diagram of a mobile computing device system architecture, according to an example implementation.

### DETAILED DESCRIPTION

To facilitate an understanding of the principles and features of implementations of the disclosed technology, various example implementations are explained below. Although some example implementations of the disclosed technology are explained in detail, other implementations are contemplated. Further, in describing the example implementations, specific terminology will be resorted to for the sake of clarity. It is not intended that the disclosed technology be limited in scope to the details of construction and arrangement of components set forth in the following description or illustrated in the drawings. Rather, the disclosed technology is capable of other implementations and of being practiced or carried out in various ways.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. Relational terms such as “first” and “second,” and the like may be used solely to distinguish one entity or action from another entity or action without necessarily requiring or implying any actual such relationship or order between such entities or actions. The term “or” is intended to mean an inclusive “or.” Further, the terms “a,” “an,” and “the” are intended to mean one or more unless specified otherwise or clear from the context to be directed to a singular form. The term “include” and its various forms are intended to mean including but not limited to.

The term “content” refers to information or data that may be presented on one or more displays associated with a computing device. By way of example, content may include any one or more of text, images, videos, audio files, executables, links to executables, UI elements, windows, workspaces, desktops, and the like. In an example implementation, content may be provided by one or more services and/or applications executing on, requested by, or transmitted to the computing device.

Various implementations of the disclosed technology relate to automatically determining whether two or more displays should present the same content. An example implementation may determine whether there is unique content for display at a logical display primarily associated with a physical display, and if not, displaying content associated with a different logical display at the physical display. Referring now to the figures, in which like reference numerals represent like parts throughout the views, various implementations of the disclosed technology will be described in detail.

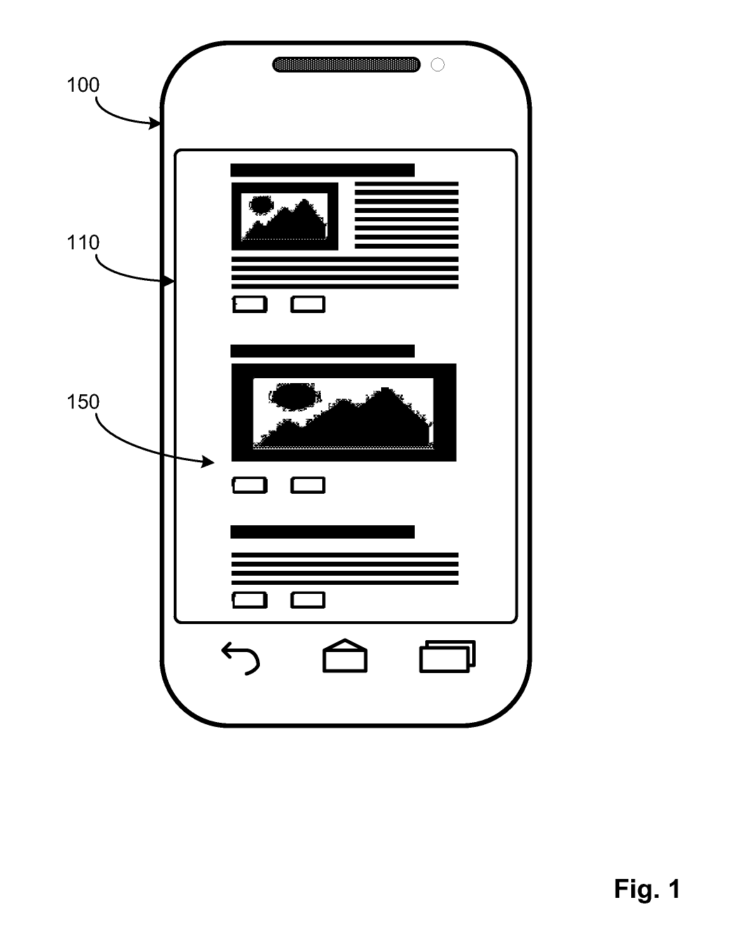

FIG. 1 depicts an example illustration of a computing device 100. As shown in FIG. 1, the computing device may be a mobile computing device, for example, a smartphone or a tablet. The computing device may have a built-in or integrated first physical display 110 for displaying content 150. The display of the mobile device may be a touch-sensitive or presence-sensitive display for receiving user input from a stylus, fingertip, or other means of gesture input. In some implementations, the computing device may be a non-mobile computing device, for example, a personal computer, with an internal or external physical display operatively connected.

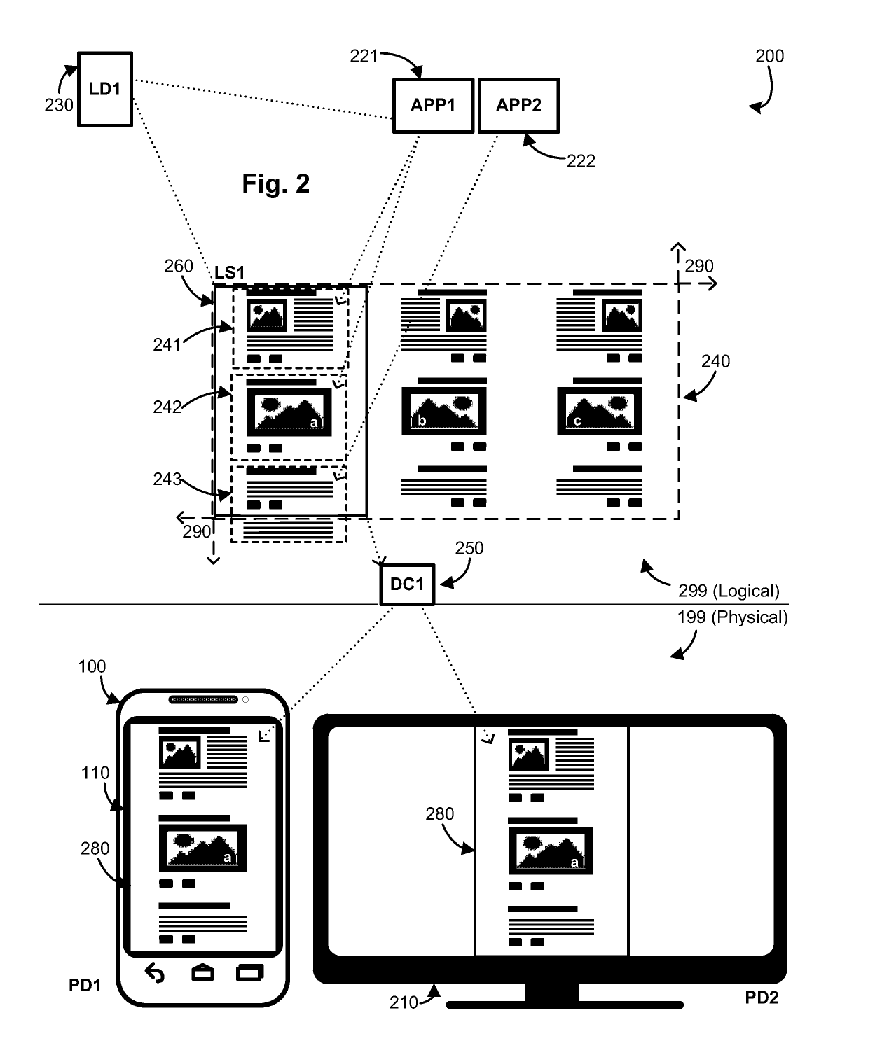

FIGS. 2-4 depict example illustrations of a multiple-display system 200. As shown in FIGS. 2-4, in certain example implementations, the system may include one or more physical 290 components including a first computing device 100. In some implementations, one or more logical 280 components of the system can reside on or be executed by the first computing device 100 and/or one or more other computing devices. The system may also include two or more physical displays, including a first physical display 110, and a second physical display 210. Although the examples herein are described in the context of a first and second physical display, it will be understood by one of skill in the art that implementations of the disclosed technology are generally applicable multiple-display systems with any number of displays.

The first and second physical displays 110, 210 may be operatively coupled to the first computing device 100. In some implementations, a physical display may be part of a display device operatively connected to the computing device through a direct link such as HDMI, MHL, USB, etc., or wirelessly using a protocol like Miracast or Wifi Display.

A physical display 110, 210 may represent a real screen or physical display area, for example, the screen of a smartphone, LCD monitor, etc., or the display area of a projector. A physical display may have a resolution, defined as width and height in pixels, a density, defined as pixels per inch as perceived from a typical viewing distance, or various other properties such as a native resolution, dot pitch, bit depth, etc. In some implementations, the system may include one or more virtual displays in addition to, or in place of, the first or second physical displays.

The system 200 may also include one or more logical displays 230, 235. A logical display may represent a region of screen real-estate (e.g., a workspace) where an application 220, 225 may present content. A logical display may also have a resolution, density, or other properties such as a descriptive name, a unique identifier, etc. In an example implementation, the system may include a default logical display 230 for associating content.

A logical display 230, 235 can be associated with one or more physical displays 110, 210. In an example implementation, a logical display can have a primary association 260 with a particular physical display. In some implementations, a logical display can have a same resolution or density as an associated physical display, for example the physical display primarily associated with the logical display.

The system 200 may include one or more applications 220, 225 or services associated with the computing device 100. In some implementations, an application can provide content for output to a physical display 110, 210 by associating content with a logical display. In an example implementation, associating content with a logical display can comprise assigning to or placing on the logical display a window associated with the application.

In certain example implementations, an application 220, 225 may be executed by one or more processors 602 on the first computing device 100. In some implementations, an application may be executed remote from the computing device.

In certain example implementations, the system 200 may also include one or more layer stacks for indirectly associating logical and physical display content. In an example implementation, a first layer stack for grouping one or more surfaces containing content may be associated with the first logical display 230, and a second layer stack may be associated with the second logical display 235. Associating content with a logical display may comprise grouping a surface of an application 220, 225 on a layer stack associated with the logical display. Outputting content for display at a physical display 110, 210 may comprise rendering a region of a layer stack corresponding to a logical display and containing parts of one or more surfaces, and outputting the rendered content for display at an associated physical display.

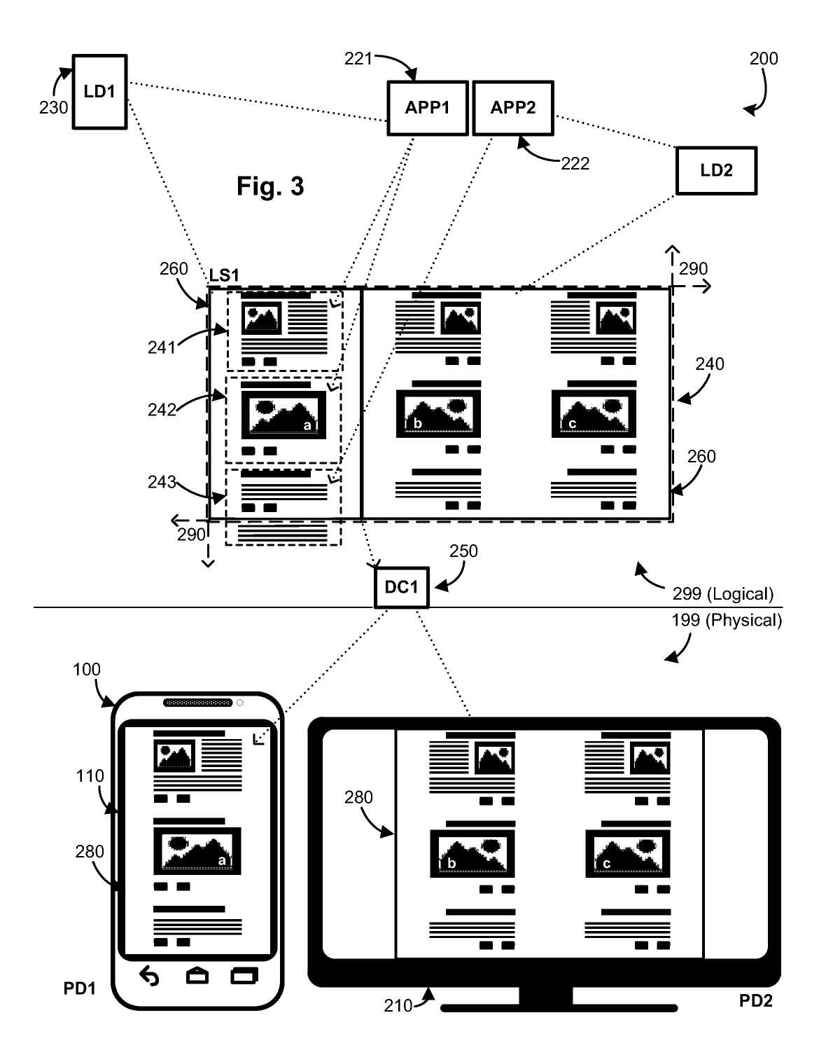

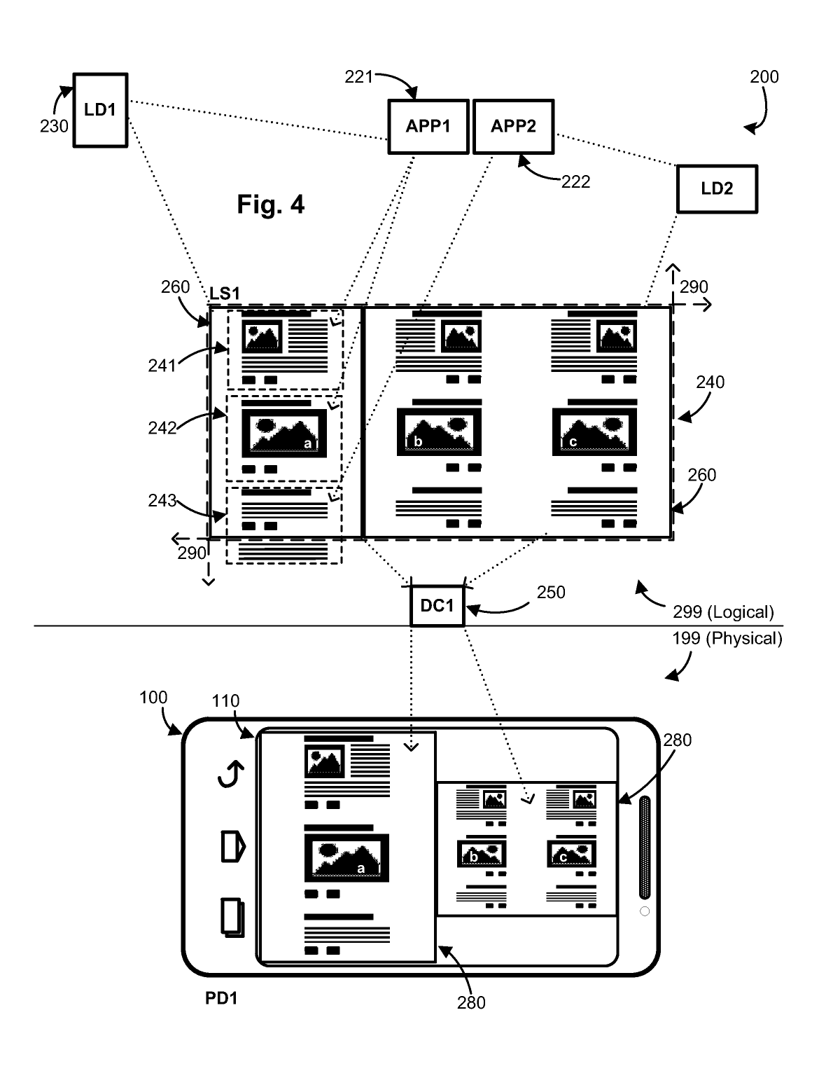

Given a system 200 configured to display content on multiple displays, a question arises as to when two or more physical displays 110, 210 should mirror the same content, as shown in FIG. 2, and when the two or more displays should display different content, as shown in FIGS. 3-4. Certain example implementations of the disclosed technology can automatically determine, without user interaction, whether to mirror content on the two or more displays based on an algorithm.

In certain example implementations, the algorithm may include, for each of two more physical displays 110, 210 in the system 200, selecting a logical display 230, 235 to be a logical display primarily associated 260 with that physical display. In some implementations, the physical display and its primary associated logical display may have a same resolution and density. In another example implementation, a logical display may be created to match a particular physical display.

In certain example implementations, the algorithm may include associating content from an application 220, 225 with a logical display 230, 235. Once content is associated with a logical display, the content can be rendered and displayed at a physical display 110, 210. In an example implementation, rendering can be performed at least in part by a display compositor (not shown) associated with the computing device 100.

In some implementations, a first application 220 can associate content with a first logical display 230, and another second application 225 can associate content with a second logical display 235, as shown in FIG. 3. For example, a word-processing application may associate a first window representing a document with a first logical display and an email-client application may associate a second window representing an email on a second logical display.

In another implementation, a single first application 220 can provide content associated with a first logical display 230 and second logical display 235, as shown in FIG. 4. For example, a media-player application may associate a first window representing controls for a media player with a first logical display, and may associate a second window representing video content to be controlled with a second logical display.

In certain example implementations, the algorithm may include determining whether there is any content associated with a logical display 230, 235 that is the primary associated logical display for a particular physical display 110, 210. If there is content associated with the logical display (i.e., content on the logical display available for viewing), the associated physical display can be directed to present the associated content. However, as shown in FIG. 2, if there is no content associated with the logical display 235 primarily associated 260 with a physical display 210, the physical display may be directed to show content associated with another logical display 230. As shown in FIG. 2, this scenario can result in two or more physical displays presenting the content from a same logical display (i.e., a mirroring display mode).

In some implementations, this second logical display can be a default logical display for the system. In another implementation, the second logical display can be any other logical display with content associated.

In some implementations, the algorithm may include determining and responding to whether there is “unique” content on a logical display 230, 235, instead of or in addition to determining and responding to whether there is any content at all. Unique content may include content of sufficient interest to warrant changing or maintaining a display configuration. For example, the algorithm may not consider content that is decorative, navigational, hidden, minimized, or otherwise deemphasized to be unique content. In some implementations, content may be classified as, or determined to be, unique based at least on properties intrinsic to the content, for example, whether the content is interactive. In other implementations, content can be considered to be unique, based at least on extrinsic properties, for example, whether there is more recent or fresher content for viewing associated with a logical display.

In some implementations, example criteria for determining unique content may include: whether the content is part of a different application than the application that has user focus; whether the content is a placeholder; whether the content is less important than other content that might be mirrored; whether the content has been interacted with less recently than other content; or whether the content is appropriate for or useful in a current user environment (for example, ignoring content that requires online access when there is no network connection available). Additional criteria for classifying or determining unique content will be apparent to one of skill in the art.

In certain example implementations, the algorithm may also include providing information to applications 220, 225 about logical displays 230, 235. In some implementations, this may comprise providing a list of logical displays in the system 200. In one implementation, the list may distinguish between “active” logical displays that may currently have content associated (see, e.g., FIG. 2, 230), and “inactive” logical displays that may not currently have content associated, for example, logical displays with no windows (see, e.g., FIG. 2, 235).

Thus, applications 220, 225 may be aware of available logical displays 230, 235, and select an appropriate logical display for the association of content. For example, in one implementation, an application may select an inactive logical display to associate content with. This may result in switching the associated physical display, which may be currently minoring content from another logical display, to display content associated its primary logical display.

However, in some implementations, an application 220, 225 need not necessarily have access to or consider information about logical displays 230, 235. Instead, an application may associate content with a default logical display. For example, a mapping application may not know about or consider a second logical display, and thus, may only open windows on a first logical display.

In some implementations, although an application 220, 225 may initially choose a first logical display 230, 235 with which to associate content, heuristics, user-input, or other factors may result in the reassignment of all or part of the content to a second logical display. For example, a first application could open two windows on a same logical display. One of the two windows could be re-associated with a second logical display, for example, by a user “dragging” a window to another display. Upon or in response to the dragging, an example implementation could evaluate the availability of content for the relevant displays, and direct a physical display to present content from another logical display, if appropriate.

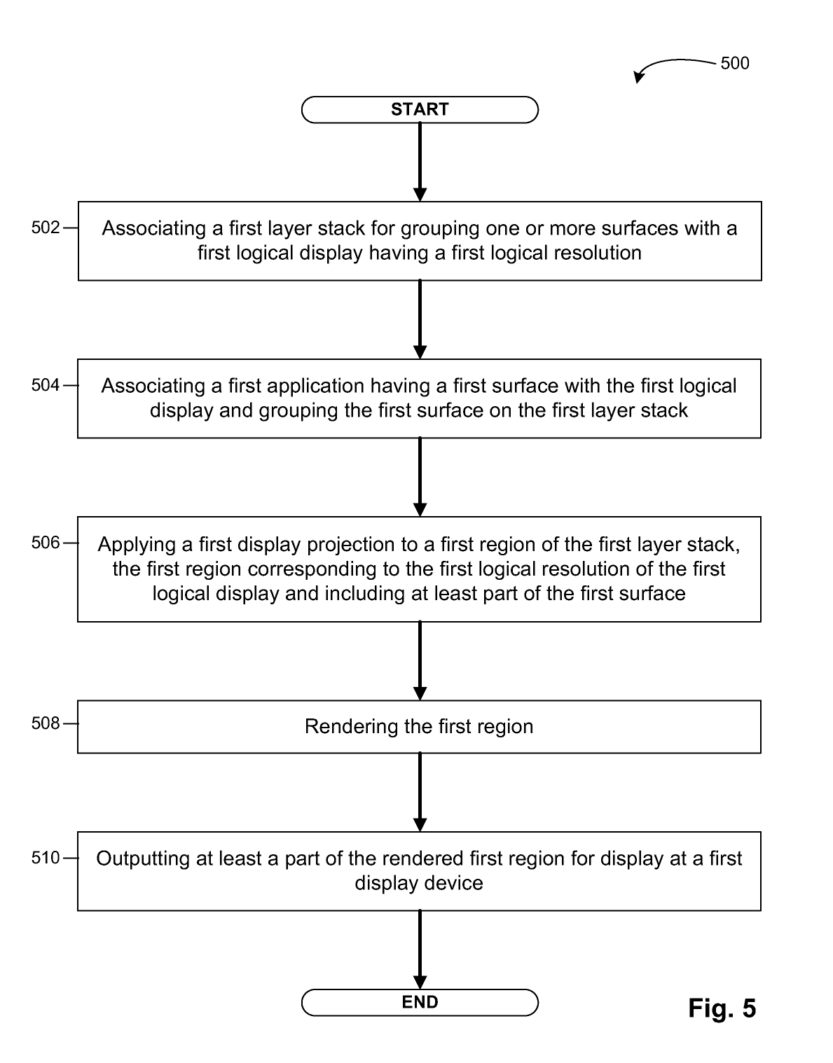

An example method 500 implementing the algorithm for determining when two or more displays should present the same or different content will now be described with reference to the flow diagram of FIG. 5.

The method 500 starts in block 502, and according to an example implementation includes associating a first display device with a first logical display, wherein the first logical display is a default logical display. In block 504, the method 500 includes associating a second display device with a second logical display. In block 506, the method 500 includes outputting, for display at the first display device, a first content for viewing associated with the default logical display. In block 508, the method 500 includes outputting, for display at the second display device, the first content. In block 510, the method 500 includes determining that there is a second content for viewing associated with the second logical display. In block 512, the method 500 includes stopping, based on the determining, output of the first content for display at the second display device. In block 514, the method 500 includes outputting, for display at the second display device, the second content, after stopping output of the first content.

Various implementations of the disclosed technology may be embodied in non-transitory computer readable media for execution by a processor. An example implementation may be used in an application of a mobile computing device, such as a smartphone or tablet, but other computing devices, including non-portable computing devices, may also be used.

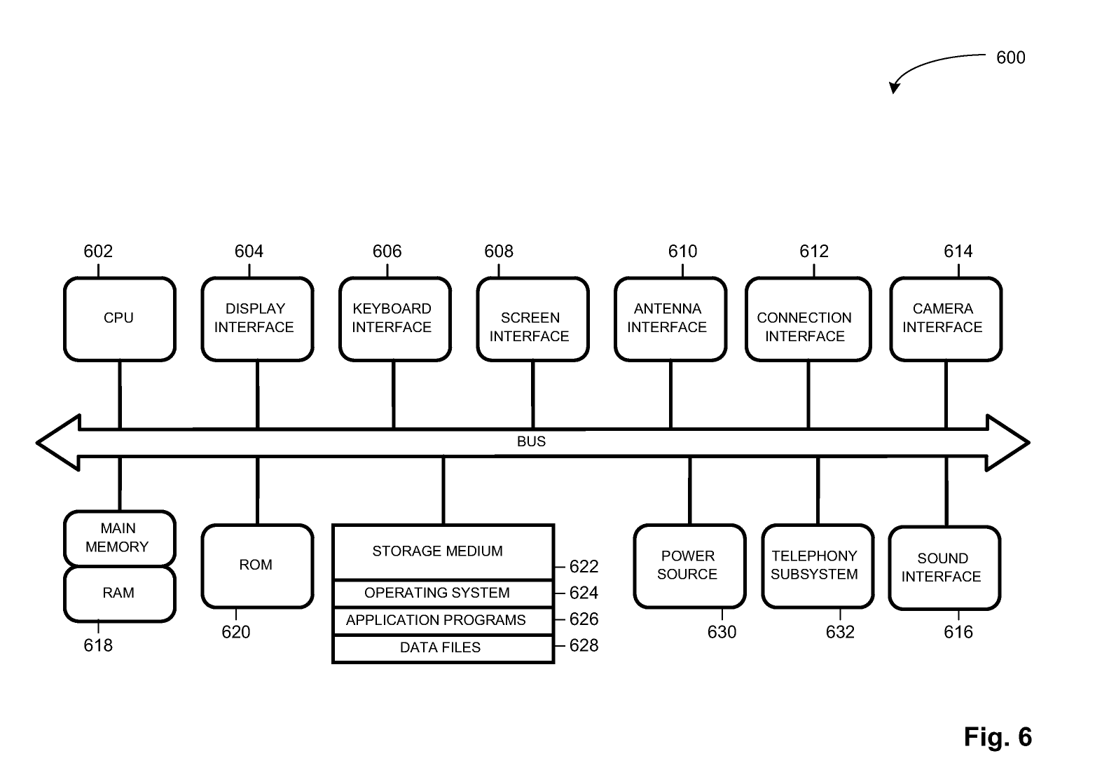

FIG. 6 depicts a block diagram of an illustrative computer system architecture 600 according to an example implementation. Certain aspects of FIG. 6 may be embodied in a computing device (for example, the mobile computing device 100 as shown in FIG. 1). Various implementations and methods herein may be embodied in non-transitory computer readable media for execution by a processor. It will be understood that the architecture 600 is provided for example purposes only and does not limit the scope of the various implementations of the communication systems and methods.

The architecture 600 of FIG. 6 includes a central processing unit (CPU) 602, where computer instructions are processed; a display interface 604 that acts as a communication interface and provides functions for rendering video, graphics, images, and texts on coupled displays; a keyboard interface 606 that provides a communication interface to a keyboard; and a pointing device interface 608 that provides a communication interface to a pointing device, e.g., a touchscreen or presence-sensitive screen. Example implementations of the architecture 600 may include an antenna interface 610 that provides a communication interface to an antenna. Example implementations may include a connection interface 612. The connection interface may include one or more of a peripheral connection interface and network communication interface, providing a communication interface to an external device or network. In certain implementations, a camera interface 614 may be provided that acts as a communication interface and provides functions for capturing digital images from a camera. In certain implementations, a sound interface 616 may be provided as a communication interface for converting sound into electrical signals using a microphone and for converting electrical signals into sound using a speaker. According to example implementations, a random access memory (RAM) 618 may be provided, where computer instructions and data may be stored in a volatile memory device for processing by the CPU 602.

According to an example implementation, the architecture 600 may include a read-only memory (ROM) 620 where invariant low-level system code or data for basic system functions such as basic input and output (I/O), startup, or reception of keystrokes from a keyboard are stored in a non-volatile memory device. According to an example implementation, the architecture 600 may include a storage medium 622 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 624, application programs 626 (including, for example, a web browser application, a widget or gadget engine, and or other applications, as necessary) and data files 628 are stored. According to an example implementation, the architecture 600 may include a power source 630 that provides an appropriate alternating current (AC) or direct current (DC) to power components. According to an example implementation, the architecture 600 may include a telephony subsystem 632 that allows the device 600 to transmit and receive sound over a telephone network. The constituent devices and the CPU 602 may communicate with each other over a bus 634.

In accordance with an example implementation, the CPU 602 may have appropriate structure to be a computer processor. In one arrangement, the computer CPU 602 may include more than one processing unit. The RAM 618 may interface with the computer bus 634 to provide quick RAM storage to the CPU 602 during the execution of computing programs such as the operating system application programs, and device drivers. More specifically, the CPU 602 may load computer-executable process steps from the storage medium 622 or other media into a field of the RAM 618 in order to execute computing programs. Data may be stored in the RAM 618, where the data may be accessed by the computer CPU 602 during execution. In one example configuration, the device 600 may include at least 128 MB of RAM, and 256 MB of flash memory.

The storage medium 622 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media may allow the device 600 to access computer-executable process steps, application programs and the like, stored on removable and non-removable memory media, to off-load data from the device 600 or to upload data onto the device 600. A computer program product, such as one utilizing a communication system may be tangibly embodied in storage medium 622, which may comprise a machine-readable storage medium.

In an example implementation of the disclosed technology, the mobile computing device computing system architecture 600 may include any number of hardware and/or software applications 220, 225 that are executed to facilitate any of the operations. In an example implementation, one or more I/O interfaces may facilitate communication between the mobile device computing system architecture 600 and one or more input/output devices. For example, a universal serial bus port, a serial port, a disk drive, a CD-ROM drive, and/or one or more user interface devices, such as a display, keyboard, keypad, mouse, control panel, touchscreen display, microphone, etc., may facilitate user interaction with the mobile device computing system architecture 600. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the mobile device computing system architecture 600 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, a proximity network, etc., for communication with external devices and/or systems. As desired, implementations of the disclosed technology may include the mobile device computing system architecture 600 with more or less of the components illustrated in FIG. 6.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
associating a first display device with a first logical display, wherein the first logical display is a default logical display;
associating a second display device with a second logical display;
providing a list of available logical displays for association, including the first logical display and the second logical display, to a first application and to a second application different from the first application;
responsive to receiving an indication from the first application to associate first content with the first logical display, outputting, for display at the first display device, the first content, and outputting, for display at the second display device, the first content;
responsive to receiving an indication from the second application to associate second content with the second logical display, determining that there is second content for viewing associated with the second logical display and stopping, based on the determining, output of the first content for display at the second display device; and
outputting, for display at the second display device, the second content, after stopping output of the first content at the second display device.

2. The method of claim 1 further comprising:
determining that there is no second content for viewing associated with the second logical display;
stopping, based on the determining, output of the second content for display at the second display device; and
outputting, for display at the second display device, the first content, after stopping output of the second content.

3. The method of claim 1, wherein the first logical display has a same first resolution and density as the first display device, and wherein the second logical display has a same second resolution and density as the second display device.

4-6. (canceled)

7. The method of claim 1 further comprising:
associating a first layer stack for grouping one or more surfaces with the first logical display;
grouping a first surface of the first application on the first layer stack;
associating a second layer stack for grouping one or more surfaces with the second logical display; and
grouping a second surface of the second application on the second layer stack;
wherein determining that there is a second content for viewing comprises determining that there are one or more surfaces for viewing grouped on the second layer stack.

8. A system comprising:
a first display device associated with a first logical display, wherein the first logical display is a default logical display;
a second display device associated with a second logical display;
at least one processor operatively coupled to the first display device and the second display device;
at least one memory operatively coupled to the at least one processor and configured for storing data and instructions that, when executed by the at least one processor, cause the system to:
provide a list of available logical displays for association, including the first logical display and the second logical display, to a first application and to a second application different from the first application;
responsive to receiving an indication from the first application to associate the first content with the first logical display, output, for display at the first display device, first content for viewing associated with the default logical display;
output, for display at the second display device, the first content;
responsive to receiving an indication from the second application to associate the second content with the second logical display, determine that there is second content for viewing associated with the second logical display; and
output, for display at the second display device, the second content;
wherein the second content replaces the first content for display at the second display device.

9. The system of claim 8, wherein the instructions, when executed by the at least one processor, further cause the system to:
determine that there is no second content for viewing associated with the second logical display; and
output, for display at the second display device, the first content;
wherein the first content replaces the second content for display at the second display device.

10. The system of claim 8, wherein the first logical display has a same first resolution and density as the first display device, and wherein the second logical display has a same second resolution and density as the second display device.

11-13. (canceled)

14. The system of claim 8 further comprising:
a first layer stack for grouping one or more surfaces associated with the first logical display; and
a second layer stack for grouping one or more surfaces associated the second logical display;
wherein the instructions, when executed by the at least one processor, further cause the system to:
group a first surface of the first application on the first layer stack; and
group a second surface of the second application on the second layer stack; and
wherein determining that there is second content for viewing comprises determining that there are one or more surfaces for viewing grouped on the second layer stack.

15. A non-transitory computer-readable medium that stores instructions that, when executed by at least one processor in a system, cause the system to perform a method comprising:
associating a first display device with a first logical display, wherein the first logical display is a default logical display;
associating a second display device with a second logical display;
providing a list of available logical displays for association, including the first logical display and the second logical display, to a first application and to a second application;
responsive to receiving an indication from the first application to associate the first content with the first logical display, outputting, for display at the first display device, first content for viewing associated with the default logical display and outputting, for display at the second display device, the first content;
responsive to receiving an indication from the second application to associate the second content with the second logical display, determining that there is second content for viewing associated with the second logical display;
stopping, based on the determining, output of the first content for display at the second display device; and
outputting, for display at the second display device, the second content, after stopping output of the first content.

16. The method of claim 15 further comprising:
determining that there is no second content for viewing associated with the second logical display;
stopping output of the second content for display at the second display device; and
outputting, based on the determining and for display at the second display device, the first content, after stopping output of the second content.

17. The method of claim 15, wherein the first logical display has a same first resolution and density as the first display device, and wherein the second logical display has a same second resolution and density as the second display device.

18-19. (canceled)

20. The method of claim 15 further comprising:
associating a first layer stack for grouping one or more surfaces with the first logical display;
grouping a first surface of the first application on the first layer stack;
associating a second layer stack for grouping one or more surfaces with the second logical display; and
grouping a second surface of the second application on the second layer stack;
wherein determining that there is a second content for viewing comprises determining that there are one or more surfaces for viewing grouped on the second layer stack.
